(19) United States
(12) Patent Application Publication
(10) Pub. No.: US 2012/0012225 A1
(43) Pub. Date: Jan. 19, 2012

(54) Method of filling CNG tanks

(76) Inventors: Marc Moszkowski, Houston, TX (US); Benton Frederick Baugh, Houston, TX (US)

(21) Appl. No.: 12/804,259

(22) Filed: Jul. 19, 2010

(51) Int. Cl. F17C 5/06

(52) U.S. Cl. 141/4; 137/14

(57) ABSTRACT

The method of charging a tank with a gas product up to a desired pressure and temperature without increasing the gas in the tank to a pressure and temperature higher than a desired pressure and temperature, comprising pressurizing the incoming gas to be put into the tank to a pressure equal to or higher than the pressure of the resident gas already in the tank, cooling the incoming gas to a temperature lower than the resident gas, mixing the incoming gas with the resident gas up to the desired pressure such that the pressure and temperature of the combined gas will be increased without increasing the temperature and pressure of the resident gas to a pressure and temperature higher than the desired pressure or temperature.

### TECHNICAL FIELD

This invention relates to the general subject of filling compressed natural gas tanks with gas without over pressuring the tanks.

### CROSS-REFERENCE TO RELATED APPLICATIONS

Not applicable.

### STATEMENT REGARDING FEDERALLY SPONSORED RESEARCH OR DEVELOPMENT

Not applicable

### REFERENCE TO A “MICROFICHE APPENDIX”

Not applicable

### BACKGROUND OF THE INVENTION

The field of this invention of that of charging or increasing the pressure in tanks with a gas product with a relatively high pressure. If such a tank is desired to be charged to a specific pressure such as 2000 p.s.i., it is charged as a progressive process. During this process a portion of this gas is input at a lower pressure such as at 1000 p.s.i. and at a temperature such as 72 degrees F., the volume will be approximately reduced by approximately one half when the pressure is brought up to 2000 p.s.i. During the remainder of the process this gas which was at a temperature at 1000 p.s.i., increases to about 200 degrees when it reaches 2000 p.s.i. If the pressure is simply pumped up to 2000 p.s.i., when the temperature cools back to 72 degrees F. the pressure will drop considerably.

This means that if you want to transport a product at 2000 p.s.i., you will need to overpressure the tanks to a higher pressure such that it will cool back to a combination of 72 degrees F. and 2000 p.s.i. In realistic terms, this may well mean that the pressure must be pumped up to 2500 p.s.i. This means that the pressure vessel needs to be designed with a working pressure of 2500 p.s.i. rather than a working pressure of 2000 p.s.i., with an extra 25% material weight simply to hold the pressure. This extra weight represents a substantial metal and weight cost, as well as a net reduction in the volume of gas product which can be transported in a vessel of a given size.

### BRIEF SUMMARY OF THE INVENTION

The object of this invention is to provide a method of charging a tank system to a working pressure without having to over design the tank system due to temperature variations in the gas.

A second object of the present invention is to provide a method of charging a gas tank in which the temperature of the charging gas is reduced by an amount to compensate for the compression heat gained in the gas which is already in the tank.

A third object of this invention is to provide

Another object of the present invention

### BRIEF DESCRIPTION OF THE DRAWINGS

FIG. 1 is a view of a vessel having the filling method of this invention.

FIG. 2 is a view of the vessel of FIG. 1 with the top deck removed and showing a set of tanks about to be installed.

FIG. 3 is a view of the vessel of FIG. 2 with a full complement of storage bottles installed.

FIG. 4 is a schematic of method of the present invention.

### DETAILED DESCRIPTION OF THE INVENTION

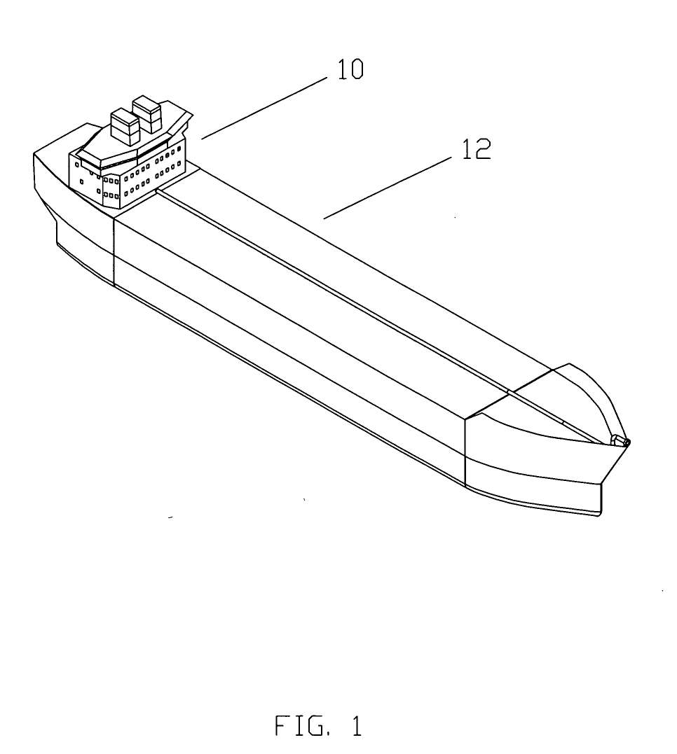

Referring now to FIG. 1, an offshore tanker 10 is shown which has a substantial central portion 12 which contains gas storage tanks.

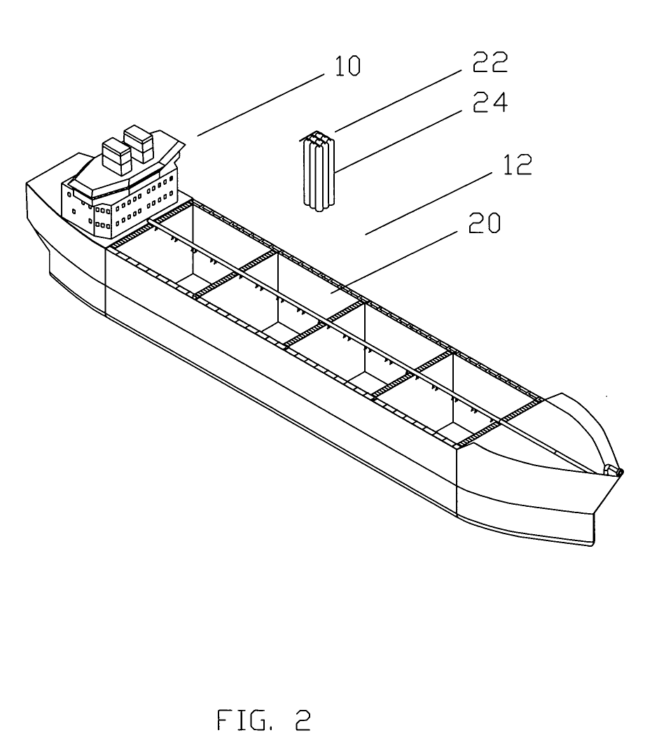

Now referring to FIG. 2, the offshore tanker 10 is shown with the top cover from the central portion 12 removed and showing a number of storage chambers 20. A bank of storage bottles 22 is shown with one of the individual bottles identified as 24. Individual bottles can be of a variety of sizes, for example 4 feet in diameter by 34 feet long.

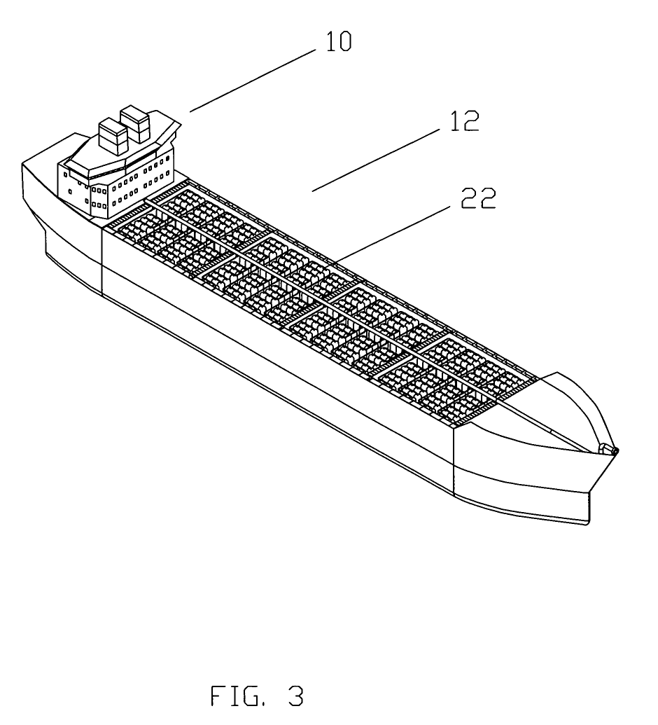

Referring now to FIG. 3, offshore tanker 10 is shown with more of the double wall covering from central portion 12 removed and a full set of bottles 22 installed. In this model 576 of the bottles 12 are shown. For each of the 576 bottles to be 25% lighter would comprise a substantial weight savings. If one presumes the same 576 bottles are in the same configuration, it would mean that they were the same outer diameter. This means that the 25% of metal removed yields a larger internal volume of the tank for higher gas transportation capacity. This means the tanks cost less, weigh less and so require less fuel to move, but have greater capacity of product.

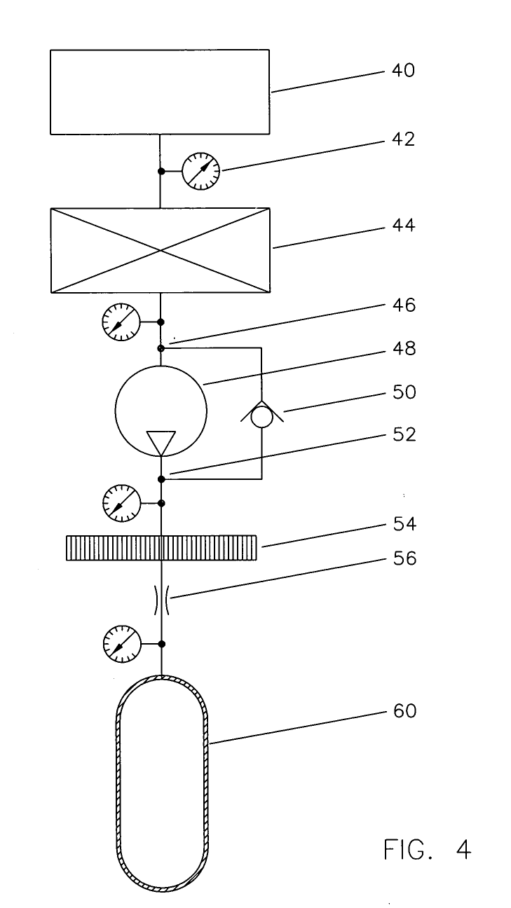

Referring now to FIG. 4, a graphic of the pumping system of this invention is shown. At the top of the schematic, the supply of gas 40 is shown being produced at some pressure as is shown on the pressure gauge 42. The gas is piped to processing equipment at 44. The supply of gas 40 will be processed through processing equipment 44 to remove unwanted elements by processes such as filtering and low pressure evaporation.

At the exit of the processing equipment 44 a tee 46 is seen with one outlet going to a pump 48 and another bypassing the pump 48 through a check valve 50. Another tee 52 is placed downstream of the pump 48 and joins the flow through the check valve 50 and the flow through the pump 48. The purpose of this is to allow initial pressures coming out of the process equipment 44 to simply bypass the pump 48 and flow into the bottles 24.

Once the pressure in the bottle 24 exceeds the pressure coming out of the process equipment 44, the gas will no longer flow through the check valve 50. The pump will then pump the gas to a pressure higher than the pressure in the bottle 24, for example 25% higher. The compressed gas will become hot as a natural effect of being compressed. The hot compressed gas will be cooled through a cooler 54 to be approximately the temperature of the gas resident in the bottle 24. The compressed and cooled gas is then lowered in pressure by going though a choke 56, with the resulting temperature being lower than the gas 60 in the bottle 24.

At this point the cool gas flows into the tank and cools the resident gas 60 by mixing as it heats the resident gas by compression. When the compression and precooling are properly set, the cooling by mixing and the heating by compression can be balanced. This says that if you want to ship gas at 2000 p.s.i. and 72 degrees F., you can build a tank rated for 2000 p.s.i. and 72 degrees F. to do the job. You do not have to overdesign it to handle 2500 p.s.i. and 200 degrees F.

In a particular application of interest, the gas comes with 20% carbon dioxide by volume. Daily gas delivery is 1,288 MT/day. The initial gas pressure is about 200 bar (2,800 psi) at temperature 140 C (284 F). Overall the gas will see its pressure drop before it enters the bottles. In the process CO2 is separated as a liquid which later is used as a refrigerant by vaporizing it before release to the atmosphere.

Cooling through a water exchanger only (Process 1): the heat capacity of the gas is about 2.5 that of water. Considering that the sea temperature is 30 C (86 F) and should exit the heat exchanger at 40 C (104 F) and assuming the gas (or rather supercritical fluid) enters at 140 C (284 F) and exits at 40 C (104 F), the total water volume entering the exchanger would be 120 l per second. The flow decreases dramatically if process 3 as described following is used.

Cooling due to pressure drop (Process 2): according to initial calculations, the gas temperature drop due to pressure drop through the valve when entering the blocks will be 75 C (135 F) when starting the loading operation and will taper off to 10 C (50 F) upon loading completion. The exiting fluid temperature would be −35 C (−31 F) to +30 C (86 F) depending on loading completion. In both states CO2 is a liquid at pressures exceeding 75 bar (1,050 psi).

The pressurized liquid CO2 can be used in an evaporator to lower the temperature of the liquid or supercritical fluid further (Process 3). If there is condensation in the exchanger the heat of evaporation equals the heat of liquefaction. Also, the process can be used to decrease the temperature of the fluid without change of phase by 85 C (153 F) from 140 to 55 C (284 to 131 F). A combination of 1 and 3 can also be used.

In short, the combination of 20% of carbon dioxide and the pressures and temperatures encountered will make possible the separation of liquid CO2 without a need to re-pressurize.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

That which is claimed is:

1. The method of charging a tank with a gas product up to a desired pressure and temperature without increasing the gas in said tank to a pressure and temperature higher than said desired pressure and temperature, comprising:
pressurizing the incoming gas to be put into said tank to a pressure higher than the pressure of the resident gas already in said tank,
allowing said incoming gas to expand to a lower pressure to cool said incoming gas to a temperature lower than said resident gas,
mixing said incoming gas with said resident gas up to said desired pressure such that the pressure and temperature of the combined gas will not be higher than said desired pressure or temperature.

2. The method of claim 1 further comprising cooling said incoming gas prior to allowing said incoming gas to expand.

3. The method of claim 1 further comprising cooling said incoming gas by expansion through an orifice.

4. The method of claim 1 further comprising said tank comprising a multiplicity of individual tanks which are interconnected by piping.

5. The method of claim 4 further comprising said multiplicity of tanks are on a ship for ocean transport.

6. The method of charging a tank with a gas product up to a desired pressure and temperature without increasing the gas in said tank to a pressure and temperature higher than said desired pressure and temperature, comprising:
cooling the incoming gas to be put into said tank to a temperature lower than the temperature of the resident gas already in said tank,
mixing said incoming gas with said resident gas up to said desired pressure and temperature such that the pressure or temperature of the combined gas will not be higher than said desired pressure or temperature.

7. The method of claim 6 further comprising cooling said incoming gas by expansion through an orifice.

8. The method of claim 6 further comprising said tank comprising a multiplicity of individual tanks which are interconnected by piping.

9. The method of claim 8 further comprising said multiplicity of tanks are on a ship for ocean transport.

10. The method of charging a tank with a gas product up to a desired pressure/temperature combination without increasing the gas in said tank to a pressure/temperature combination higher than said desired pressure/temperature combination, comprising:
pressurizing the incoming gas to be put into said tank to a pressure equal to or higher than the pressure of the resident gas already in said tank,
cooling said incoming gas to a temperature lower than said resident gas,
mixing said incoming gas with said resident gas up to said desired pressure/temperature combination such that the pressure/temperature combination of the combined gas will be increased without increasing the temperature/pressure combination of the resident gas to a pressure/temperature combination higher than said desired pressure/temperature combination.

11. The invention of claim 10, further comprising said incoming gas will be cooled by expansion to a lower pressure through an orifice.

12. The method of claim 10 further comprising said tank comprising a multiplicity of individual tanks which are interconnected by piping.

13. The method of claim 12 further comprising said multiplicity of tanks are on a ship for ocean transport.
